(19) United States
(12) Patent Application Publication
(10) Pub. No.: US 2006/0155536 A1
(43) Pub. Date: Jul. 13, 2006

(54) Method and device for displaying a telephone number

(76) Inventors: Roland E. Williams, Martinez, CA (US); Jacques LaPointe, Calgary (CA)

Correspondence Address: HODGSON RUSS LLP, ONE M & T PLAZA, SUITE 2000, BUFFALO, NY, 14203-2391, US

(21) Appl. No.: 11/312,000

(22) Filed: Dec. 19, 2005

Related U.S. Application Data
(60) Provisional application No. 60/637,597, filed on Dec. 20, 2004.

(51) Int. Cl. G10L 15/26

(52) U.S. Cl. 704/235

(57) ABSTRACT

Devices and methods of displaying a telephone number are disclosed. The telephone number may be displayed in a manner that is likely to be helpful to the user of an appliance, such as a cell phone or personal digital assistant.

### CROSS-REFERENCE TO RELATED APPLICATION

This application claims the benefit of priority to U.S. provisional patent application Ser. No. 60/637,597, filed on Dec. 20, 2004.

### FIELD OF THE INVENTION

The present invention relates to methods and devices for displaying telephone numbers.

### BACKGROUND OF THE INVENTION

The complexity of electronic appliances, such as cellular telephones, and the numerous software components that can be installed to operate those appliances have made it necessary for the designers to provide ways to access components with less effort. Once a user reaches a component, it is usually helpful, if not necessary, to allow the user to utilize a component with minimal effort in order to make the experience of using the component as pleasant as possible. For example, many cell phones offer text messaging, but due to the small size of the key pad, methods of making text entry easier have been provided. In most cell phones, one such method utilizes a prediction algorithm which predicts the text the user may be trying to enter, and if the user identifies a piece of predicted text, the user is allowed to select the predicted text, thereby saving the user from entering each and every character comprising the text.

Even with modern methods, electronic appliances can be difficult to use. The amount of information that may be stored in an appliance is so great, that merely predicting what the user might be trying to enter could yield a large number of possible candidates from which the user is asked to choose. This problem is particularly evident with telephone numbers. If a user enters three or four digits of a desired phone number, a large number of candidates may be presented to the user for selection. If the number of candidates is too large, the predictive nature of the appliance becomes almost worthless since the user may be required to enter many or most of the telephone number digits before a reasonable number of candidates are provided. In that situation, the task of entering enough digits to obtain a reasonable number of candidates, and then selecting the desired candidate can be more tedious than simply entering the entire telephone number.

Given the large number of possible phone numbers that may be returned to a user when entering a telephone number, a user may be best helped by providing the user with data in a way that not only displays pertinent information but does so in a fashion that is clearly and logically aligned with the user's data entry.

### SUMMARY OF THE INVENTION

The invention may be embodied as a device, such as a cell phone or personal digital assistant. One such device has a processor that is capable of executing instructions. A memory may be in communication with the processor, and the memory may have strings of numbers stored therein. A display may be in communication with the processor, and used to communicate with a user. The display may be a monitor, which may have a liquid crystal display or may be an array of light emitting diodes. Such a device may have software having instructions that are executable by the processor, and which cause the processor to (a) receive an entry, (b) identify stored strings having the entry to provide identified candidates, and (c) provide identified candidates on the display such that the entry is highlighted in each identified candidate.

The invention may be embodied as a method. In one such method, a number entry may be received, and stored strings may be identified. The identified stored strings may be those stored strings that have the entry somewhere in the string. The identified stored strings may be provided on a display as identified candidates such that the entry is highlighted in each identified candidate. The user may then be permitted to select from among the identified candidates.

The invention may be embodied as a computer readable memory device. One such memory device may have stored instructions that are executable by a computer. The instructions may be capable of causing the computer to (a) receive an entry from a user, (b) identify number strings that have the entry, and (c) provide identified candidates on the display such that the entry is highlighted in each identified candidate.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a schematic diagram of a device according to the invention, including a schematic representation of a memory device according to the invention; and

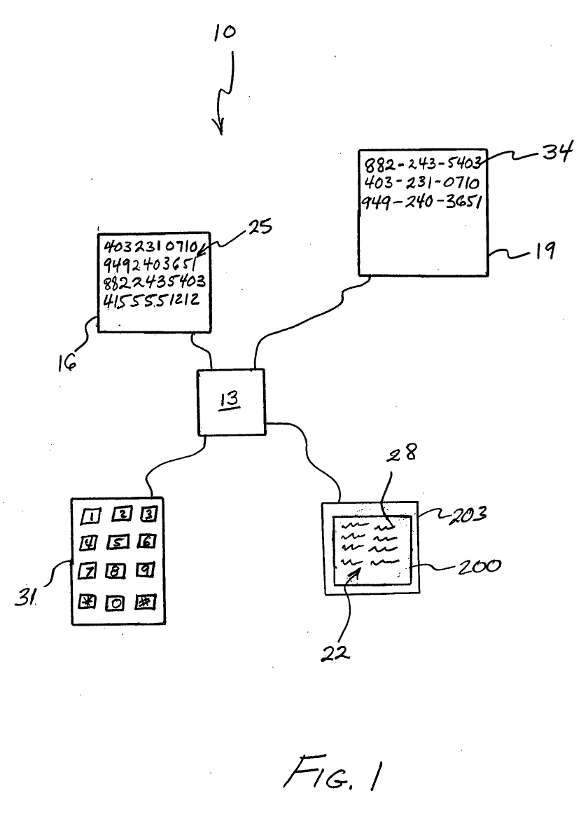

FIG. 2, which depicts a method according to the invention.

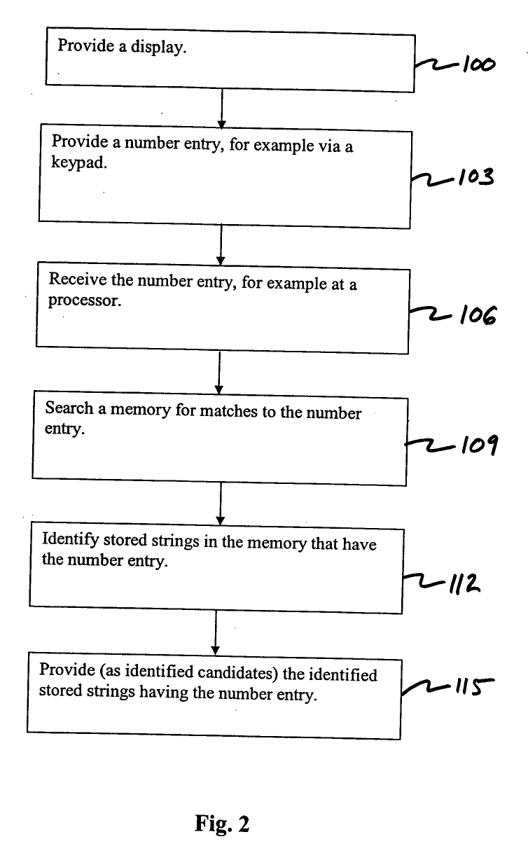

### FURTHER DESCRIPTION OF THE INVENTION

The invention may be embodied as a device 10 suitable for making a telephone call. In one such device 10, there is a processor 13, a memory 16, a display 19 and software 22. The memory 16 may have strings of numbers 25 stored therein. For example, the number strings 25 may be telephone numbers that were previously called by an owner of the device 10, or the numbers may be previously identified as being potentially desired by an owner of the device 10.

The memory 16 and the display 19 may be in communication with the processor 13, and instructions 28 in the software 22 may be executed by the processor 13 so that certain tasks are performed. For example, the instructions 28 may cause the processor 13 to identify a telephone number 25 that is stored in the memory 16, and then provide that telephone number 25 to the display 19 so that it may be viewed by a user. The user may be allowed to select a displayed telephone number, and thereby indicate the user's desire to call that telephone number 25.

The instructions 28 in the software 22 may be executable by the processor 13 to cause the processor 13 to (a) receive an entry from a keypad 31, (b) identify stored number strings 25 having the entry, and (c) provide the identified stored number strings 25 (“identified candidates 34”) on the display 19 such that the entry is highlighted in each identified candidate 34. In this manner, the user may easily determine which of the identified candidates 34 is desired. For example, if the user knows the desired telephone number has the entry at the end of the telephone number, the user may review the identified candidates 34, giving more consideration to those that have the entry at the end, than to those that have the entry elsewhere in the identified candidate 34.

The software 22 may include instructions 28 that cause the processor 13 to provide the identified candidates 34 on the display 19 so that candidates 34 having the entry at a first side of the identified candidate 34 are provided prior to candidates 34 having the entry at a second side of the identified candidate 34. For example, for telephone numbers that are read from left to right, those telephone numbers that have the entry on the right side of the number may be more likely to be desired by a user than telephone numbers that have the entry on the left side of the number, since most people remember the last digits of a telephone number more readily than the first digits of a telephone number.

For other candidates 34 that do not have the entry on the first side or the second side, the software 22 may cause the processor 13 to provide these after the candidates 34 having the entry at one of the sides. These other candidates 34 may be organized on the display 19 by placing those having the string near the first side of the candidate 34 prior to those having the string near the second side of the candidate 34. It is believed that this arrangement will provide an easy way for the user to quickly identify a desired candidate 34.

The invention may be embodied as a method. In one such method, a display may be provided 100. An input device may be used to provide 103 a number entry, and the number entry may be received 106 by the processor. The processor may search 109 the memory and identify 112 stored strings having the entry. Each stored string having the entry may be provided 115 as an identified candidate, and displayed with the entry highlighted. The identified candidates may be provided 115 as a list. The list may be organized so that those candidates having the entry at a first side of the candidate are provided 115 prior to candidates having the entry at a second side of the identified candidate. For example, the first side may be a right side of the identified candidate and the second side may be a left side of the identified candidate. Other identified candidates (“OICs” ) may be provided after the candidates having the entry at one of the sides. The OICs may be provided by placing those OICs having the string near the first side of the candidate prior to those OICs having the string near the second side of the candidate.

The invention may be embodied as a memory device 200, which may be used to carry out a method according to the invention. For example, the memory device 200 may be a computer readable memory device having stored thereon instructions 28 that are executable by a microprocessor 13 in a computer. The memory device 200 may be a programmable read-only memory device for storing software which may be coupled with a reader 203 for extracting the instructions from the memory device 200. The instructions 28 may be capable of causing a computer to (a) receive an entry from a user, (b) identify number strings that have the entry, and (c) provide identified candidates on a display 19 such that the entry is highlighted in each identified candidate. The instructions 28 may be capable of causing the microprocessor 13 to provide identified candidates on the display 19 so that the identified candidates having the entry at a first side of the identified candidate are provided prior to candidates having the entry at a second side of the identified candidate. The instructions 28 on the memory device 200 may be capable of causing the computer to provide OICs after the candidates that have the entry at one of the sides. For example, the instructions on the memory device 200 may cause the computer to provide identified candidates on a display so that those OICs having the string near the first side of the candidate are provided prior to those OICs having the string near the second side of the candidate.

Having provided descriptions of embodiments of the invention, it will be recognized that obtaining a phone number is made easier by the invention. By way of example, it is usual in business telephone systems to allow a call from one telephone internal to the company to ring another telephone internal to a company by dialing a three or four digit extension number. It is also common that those calling from outside the company will dial a longer number, which has the same last three or four digits as the extension number. Thus, by using the invention, a user need only enter, for example, the last three digits in order for the appliance to retrieve and display the full telephone number, and that telephone number may be positioned on the cell phone such that the user may easily identify the telephone number from others that may be displayed there too.

As an example, consider a user who desires to place a call to the telephone number 882 243 5403. Often a user will remember the last three or four digits of a phone number simply because of the way numbers are recorded in print, i.e., in block fashion usually ending with a group of three or four digits, or because those are the numbers dialed last and therefore remain in the user's memory, or because the user is accustomed to dialing the extension number when the user is in the office. If the user enters “403” as a means to cause the appliance to display the telephone number 8822435403, then the telephone according to the invention may search the memory of the telephone for previously stored candidates having the entered string “403”. Unfortunately, in matching strings, there may be numbers which have the “403” string in a position that is not at the end of the desired telephone number. For example, since the area code for Alberta, Canada is 403, the appliance may display previously stored phone numbers having that area code.

Because the user dialed the numeric string with a context in mind, the telephone may display the candidates so that the context is easily identifiable in order to make selection of the desired candidate more convenient. For example, if the appliance searched its memory and located the candidates 4032310710 and 9492403651 and 8822435403, then displaying these candidates with the entered string highlighted would aid the user in identifying the desired number. In this example, the user would be looking for a telephone number having the entered string “403” as the last three digits. Therefore, the candidates might be displayed as “4032310710”, followed by “9492403651”, and followed by “8822435403”. By doing so, the user's attention might be drawn to the highlighted elements at the end of the last candidate. The user would then select that last candidate and the appliance would place the call.

There are many ways to draw the user's attention to the location of an entered number within a candidate. For example, highlighting may be used, including color, italicization, font size or reverse video. In this description, the term “highlighting” is used to refer to mechanisms used to draw the user's attention to a location by displaying the highlighted portion in a manner that is different from the manner in which the unhighlighted portions are displayed. In this manner, the entered number may be differentiated from the rest of the displayed numbers in a way that catches the user's attention. This minimizes the active searching that the user must do to read from the display and select a desired candidate.

The candidates may be ordered in a manner that further assists the user. In one such order, the entered string may be displayed first, the candidates having the entered string at the end of the telephone number may be displayed next, and the candidates having the entered string at the beginning of the telephone number may be displayed next. All other candidates having the entered string may be displayed toward the end of the candidate list. This ordering may be beneficial to the user since (1) the number of telephone numbers having the entered string as the last digits is likely to be small and the likelihood that the user has entered the extension because that is the number he remembers is high, and since (2) the likelihood that the first numbers entered by the user are the area code of a desired telephone number is high, but there may be many such numbers.

Those telephone numbers that do not have the entered number in the last digits or the first digits, may be ordered by placing candidates with the entered number near the front of the candidate before those candidates having the entered number near the back of the candidate. For example, if the candidates to be displayed are “9492403651” and “2340323107” and “8822440335”, then the order might be “2340323107” followed by “9492403651” followed by “8822440335”.

In a method according to the invention, an appliance may be provided to a user, and the user may select a series of characters, such as numbers from a key pad of the appliance, to provide the appliance with a string of characters. The appliance may display the string of characters on a monitor as part of a list. The appliance may search a memory for previously stored entries having the string. Those entries having the string may be displayed as part of the list in a fashion so as to identify them as candidates for selection by the user. The list may be organized to display the string, followed by candidates having the string at the end of the candidate, followed by candidates having the string at the beginning of the candidate, followed by candidates having the string elsewhere in the candidate. Those candidates having the string elsewhere in the candidate, may be organized to display candidates having the string near the front of the candidate before those candidates having the string near the back of the candidate.

U.S. provisional patent application No. 60/637,597 discloses additional details about the invention and additional embodiments of the invention. The disclosure of that patent application is incorporated by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A device, comprising:
a processor capable of executing instructions;
a memory in communication with the processor, the memory having strings of numbers stored therein;
a display in communication with the processor; and
software having instructions that are executable by the processor to cause the processor to (a) receive an entry, (b) identify stored strings having the entry to provide identified candidates, and (c) provide identified candidates on the display such that the entry is highlighted in each identified candidate.

2. The device of claim 1, wherein the software has instructions that are executable by the processor to provide the identified candidates on the display so that candidates having the entry at a first side of the identified candidate are provided prior to candidates having the entry at a second side of the identified candidate.

3. The device of claim 2, wherein the first side is a right side of the identified candidate and the second side is the left side of the identified candidate.

4. The device of claim 2, wherein other identified candidates are provided after the candidates having the entry at one of the sides of the identified candidate.

5. The device of claim 4, wherein the other identified candidates are displayed by placing those other candidates having the string near the first side of the candidate prior to those other candidates having the string near the second side of the candidate.

6. A method of displaying candidates, comprising:
provide a display;
receive a number entry;
identify stored strings having the entry to provide identified candidates;
provide identified candidates on the display such that the entry is highlighted in each identified candidate.

7. The method of claim 6, wherein the identified candidates are provided as a list, the list being organized so that those candidates having the entry at a first side of the candidate are provided prior to candidates having the entry at a second side of the identified candidate.

8. The method of claim 7, wherein the first side is a right side of the identified candidate and the second side is the left side of the identified candidate.

9. The method of claim 7, wherein other identified candidates are provided after the candidates having the entry at one of the sides of the identified candidate.

10. The method of claim 9, wherein the other identified candidates are provided by placing those other identified candidates having the string near the first side of the candidate prior to those other identified candidates having the string near the second side of the candidate.

11. A computer readable memory device having stored thereon instructions that are executable by a computer, the instructions being capable of causing a computer to (a) receive an entry from a user, (b) identify number strings that have the entry, and (c) provide identified candidates on the display such that the entry is highlighted in each identified candidate.

12. The memory device of claim 11, wherein the instructions are capable of causing the computer to provide identified candidates on a display so that the identified candidates having the entry at a first side of the identified candidate are provided prior to candidates having the entry at a second side of the identified candidate.

13. The memory device of claim 12, wherein the instructions are capable of causing the computer to provide identified candidates on a display so that other identified candidates are provided after the candidates having the entry at one of the sides of the identified candidate.

14. The memory device of claim 13, wherein the instructions are capable of causing the computer to provide identified candidates on a display so that the other identified candidates are provided by placing those other candidates having the string near the first side of the candidate prior to those other candidates having the string near the second side of the candidate.
